(19) United States
(12) Patent Application Publication
(10) Pub. No.: US 2018/0370647 A1
(43) Pub. Date: Dec. 27, 2018

(54) EXHAUST STUB FOR AN AIRCRAFT ENGINE ASSEMBLY

(71) Applicant: General Electric Company Polska SP z o.o., Warsaw (PL)

(72) Inventor: Tomasz IGLEWSKI, Warsaw (PL)

(21) Appl. No.: 15/986,850

(22) Filed: May 23, 2018

(30) Foreign Application Priority Data
Jun. 21, 2017 (EP) 17461552.6

(51) Int. Cl. B64D 33/04; B64D 27/10

(52) U.S. Cl. CPC B64D 33/04; B64D 27/10

(57) ABSTRACT

An aircraft engine assembly can include an engine having an exhaust turbine with drive shaft and exhaust collector, a propeller rotationally coupled to the drive shaft and defining a rotational axis, and an exhaust stub to direct exhaust gases away from the aircraft.

### PRIORITY INFORMATION

The present application claims priority to European Patent Application No. 17461552.6 filed on Jun. 21, 2017.

### BACKGROUND OF THE INVENTION

Contemporary turbo-prop engine aircraft can include one or more propellers attached to engines of the aircraft. Exhaust gases generated within the engines can be directed outward via exhaust stubs. The exhaust gases' energy and exit direction through the exhaust stubs can provide additional residual thrust to that provided by the propellers.

It can be beneficial to select an exhaust direction that reduces drag on the aircraft while optimizing thrust. However, heat-sensitive components on the aircraft, such as windshields, might be impinged by hot exhaust gases from the stubs.

### BRIEF DESCRIPTION OF THE INVENTION

In one aspect, an aircraft engine assembly can include an engine having a drive shaft and exhaust collector, a propeller rotationally coupled to the drive shaft and defining a rotational axis, and an exhaust stub having an inlet fluidly coupled to the exhaust collector and an exhaust outlet having an outwardly turned tip. The exhaust stub can define a centerline, and an inboard portion of the outwardly turned tip can define a concave surface and the outboard portion of the outwardly turned tip can define a convex surface when viewed in a plane containing the centerline. The concave and convex surfaces can have the same radius of curvature, and the outwardly turned tip can extend along less than 20% of the exhaust stub.

The exhaust stub can include a first portion fluidly coupled to the exhaust collector and forming a first angle relative to the rotational axis, as well as a second portion fluidly coupled to the first portion and forming a second angle relative to the rotational axis, with the second angle being less than the first angle. The exhaust stub can also include a turn portion fluidly coupling the first and second portions, and the outwardly turned tip can be provided on the second portion. In addition, the outwardly turned tip when viewed along the rotational axis can lie within a circumferential boundary formed by a full rotation of a tip of the propeller.

The aircraft engine assembly can further include a door provided in the exhaust stub and confronting the propeller. The door can be biased open by a biasing force, where the biasing force can be less than the force of the propeller wash during flight so that the door is closed during flight, and greater than the force of the propeller wash during idle such that the door is open during idle.

In another aspect, an aircraft engine assembly can include an engine having a drive shaft with an exhaust collector, a propeller rotationally coupled to the drive shaft and defining a rotational axis, an exhaust stub having an inlet fluidly coupled to the exhaust collector and an exhaust outlet, and a door provided in the exhaust stub and operably between opened/closed conditions. The door can form part of an outer wall of the exhaust stub, or part of the exhaust outlet, and can confront the propeller. A biasing device can apply a biasing force to the door to bias the door from the closed to the open position. The biasing force can be less than the force of the propeller wash during flight so that the door is closed during flight, and can be greater than the force of the propeller wash during idle such that the door is open during idle.

In another aspect, a method of exhaust combustion gas from an engine rotating a propeller about a rotational axis can include exhausting the combustion gas from an exhaust stub at a first angle relative to the rotational axis during flight, and exhausting the combustion gas from the exhaust stub at a second angle, greater than the first angle relative to the rotational axis during idle. The method can also include forming a pressure gradient across an outlet of the exhaust stub to effect the exhausting of the combustion gas from the exhaust stub at the second angle. The method can additionally include opening a door in the exhaust stub during idle to effect the exhausting of the combustion gas form the exhaust stub at the second angle. The method can further include opening a door in the exhaust stub during idle to effect the exhausting of the combustion gas from the exhaust stub at the second angle.

### BRIEF DESCRIPTION OF THE DRAWINGS

In the drawings:

FIG. 1 is a schematic view of an aircraft including an engine assembly in accordance with various aspects described herein.

FIG. 2 illustrates the engine assembly of FIG. 1 having an exhaust stub in accordance with one aspect of the disclosure.

FIG. 3 illustrates a portion of the exhaust stub of FIG. 2.

FIG. 4 illustrates the exhaust stub of FIG. 2 with a door in a closed state.

FIG. 5 illustrates the exhaust stub of FIG. 2 with a door in an open state.

### DESCRIPTION OF EMBODIMENTS OF THE INVENTION

The described embodiments of the present disclosure are directed to an exhaust stub for an engine. For purposes of illustration, the present disclosure will be described with respect to a turboprop engine for an aircraft. It will be understood, however, that the disclosure is not so limited and may have general applicability in other aircraft engines or in other industrial, commercial, and residential applications.

All directional references (e.g., radial, axial, proximal, distal, upper, lower, upward, downward, left, right, lateral, front, back, top, bottom, above, below, vertical, horizontal, clockwise, counterclockwise, upstream, downstream, forward, aft, etc.) are only used for identification purposes to aid the reader's understanding of the present disclosure, and do not create limitations, particularly as to the position, orientation, or use of the disclosure. Connection references (e.g., attached, coupled, connected, and joined) are to be construed broadly and can include intermediate members between a collection of elements and relative movement between elements unless otherwise indicated. As such, connection references do not necessarily infer that two elements are directly connected and in fixed relation to one another. The exemplary drawings are for purposes of illustration only and the dimensions, positions, order and relative sizes reflected in the drawings attached hereto can vary. In addition, “a set” as used herein can include any number of a particular element, including only one.

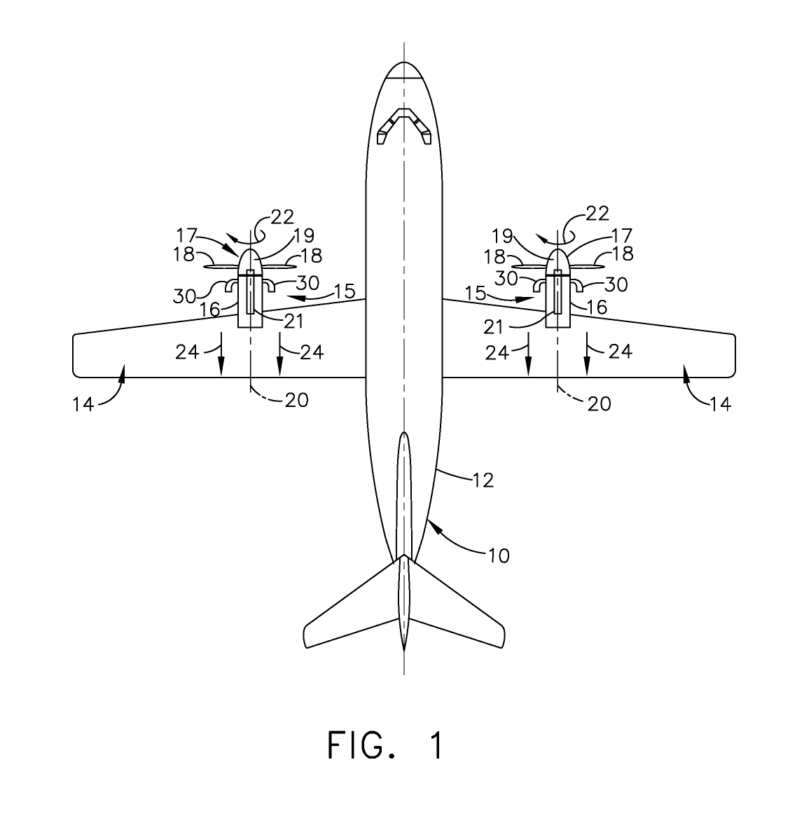

FIG. 1 depicts an aircraft 10 having a fuselage 12 and wings 14 extending outward from the fuselage 12. The aircraft 10 can include at least one engine assembly 15 such as a turbo-prop aircraft engine 16 coupled to the aircraft 10, shown as a set of engines 16 coupled with wings 14. The engine 16 can include a set of propeller assemblies 17 coupled with the engine 16, and including propeller blades 18 and a rotatable hub assembly 19. A drive shaft 21 within the engine 16 can drive the propeller assembly 17 about a propeller assembly rotational axis 20 in a direction indicated by the arrow 22. The propeller blades 18 can further be configured or angled relative to the propeller assembly rotational axis 20 such that the rotation 22 of the propeller blades 18 generates thrust (illustrated as arrow 24) for the aircraft 10. Exhaust stubs 30 can extend outward from the engine 16 to direct exhaust gases away from the engine 16 (or any heat-sensitive components on the fuselage 12 or wings 14) in addition to generating additional thrust for the aircraft 10.

While an aircraft 10 having two turbo-prop engines 16 has been illustrated, embodiments of the disclosure can include any number of engines 16, propeller assemblies 17, or propeller blades 18, or any placement of the engine 16, assemblies 17, or blades 18 relative to the aircraft. Embodiments of the disclosure can further be applied to different aircraft engine types, including, but not limited to, piston-based combustion engines, or electrically-driven engines. Additionally, the rotation 22 of the propeller assemblies 17 or propeller blades 18 is provided for understanding of the embodiments of the disclosure. Embodiments of the disclosure can include alternative directions of rotation 22 of the propeller assemblies 17 or propeller blades 18, or embodiments wherein a set of engines 16 rotate propeller blades 18 in the same or opposing directions.

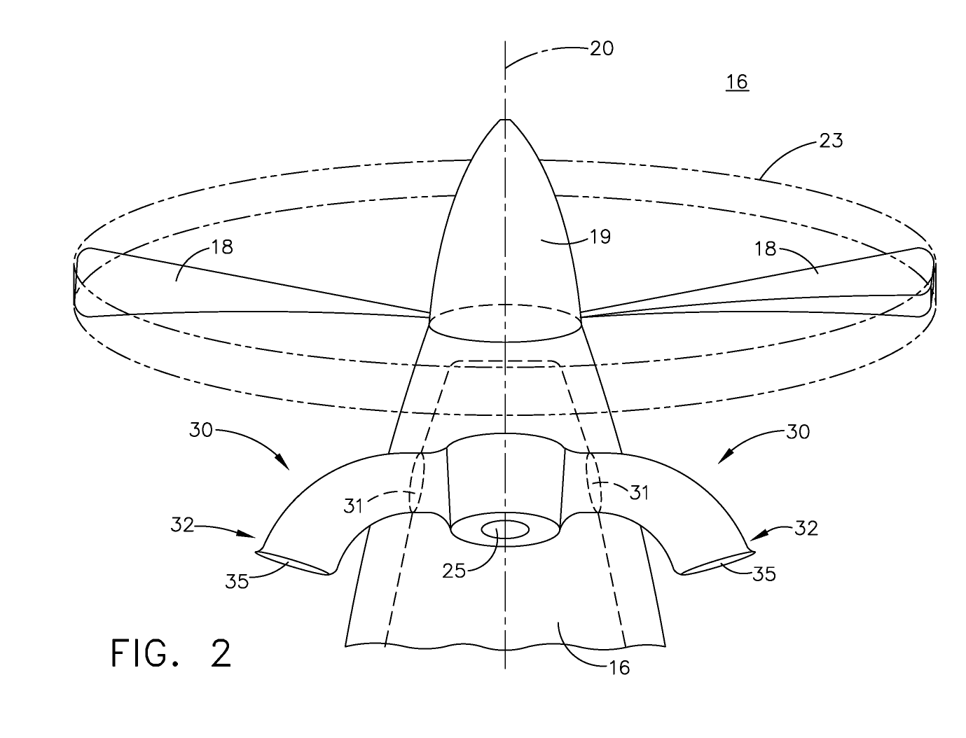

The exhaust stubs 30 can be seen in further detail in FIG. 2. The exhaust stub 30 can include an inlet 31 fluidly coupled to an exhaust collector 25 within the engine 16, as well as an exhaust outlet 32 having a tip 35 which can be outwardly turned as shown. The propeller blades 18 can define a circumferential boundary 23 formed by a full rotation of the tips of the blades 18; when viewed in a direction along the rotational axis 20, the exhaust outlet tip 35 can lie within the circumferential boundary 23.

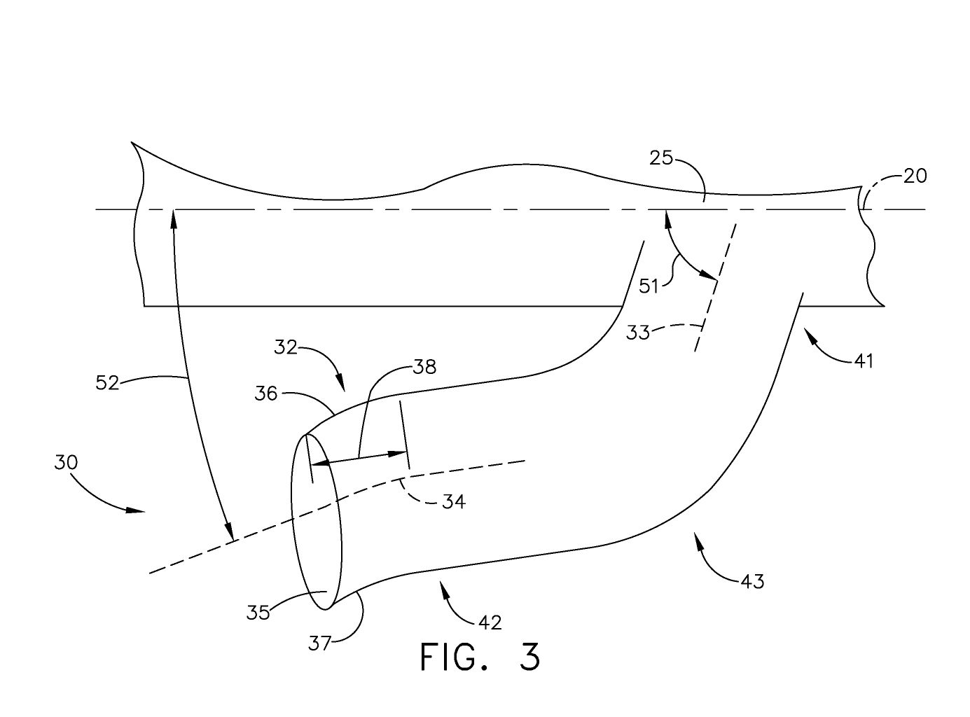

Turning to FIG. 3, exhaust stub 30 can include an inlet centerline 33, outlet centerline 34, first portion 41 fluidly coupled to the exhaust collector 25, and second portion 42 fluidly coupled to the first portion 41. The first portion 41 can include the inlet centerline 33 to form a first angle 51 with the rotational axis 20. The second portion 42 can include the tip 35 and exhaust outlet centerline 34 to form a second angle 52 with the rotational axis 20, and it is contemplated that the second angle 52 can be less than the first angle 51. In addition, a turn portion 43 of the exhaust stub 30 can fluidly couple the first and second portions 41, 42.

The tip 35 of the exhaust stub 30 can further include an inboard portion 36 and outboard portion 37. When viewed in a plane containing the exhaust outlet centerline 34, the inboard portion 36 can define a concave surface while the outboard portion 37 can define a convex surface with respect to the centerline 34. It will be understood that the inboard and outboard portions 36, 37 can have the same or differing radii of curvature, and are illustrated in the example of FIG. 3 as having the same radius of curvature to form the outwardly turned tip 35. In addition, the outwardly turned tip 35 can have a linear extent 38 that can be less than 20% of a length (for example the curvilinear length) of the exhaust stub 30.

In operation, exhaust gases generated within the engine 16 can flow through the exhaust collector 25 and exhaust stub 30 before exiting through the tip 35. The outwardly turned tip 35 can form a pressure gradient with a higher-pressure region near the concave surface of the inboard portion 36 and a lower-pressure region near the convex surface of the outboard portion 37. The pressure gradient at the tip 35 can direct the flow of exhaust gases through the stub 30 toward the outboard portion 37 and away from the engine 16. It is contemplated that the exhaust gases can exit the exhaust stub 30 while forming a larger angle with the rotational axis 20 than the second angle 52.

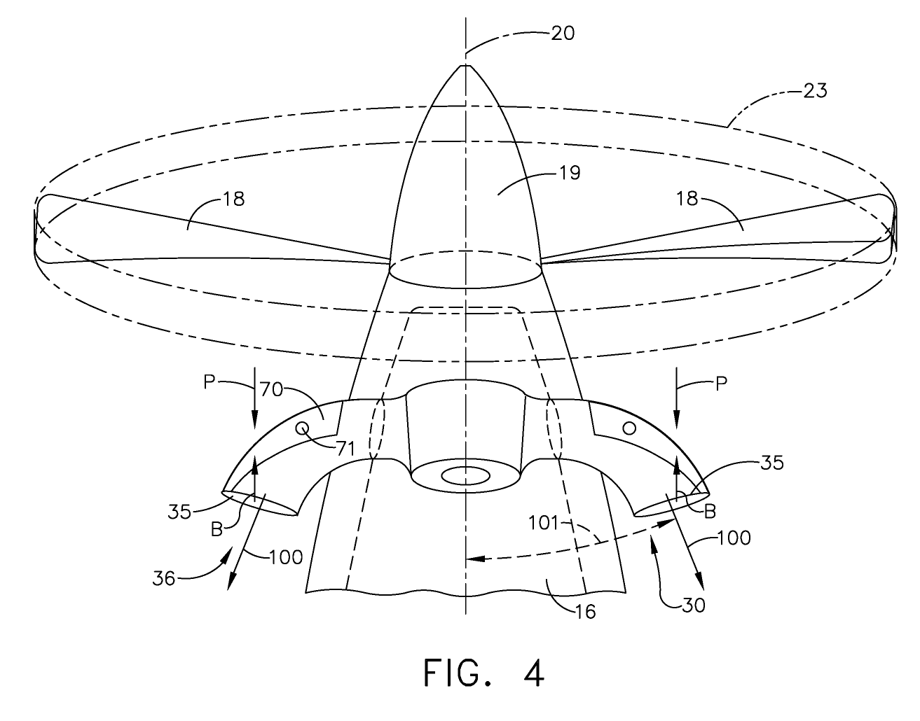

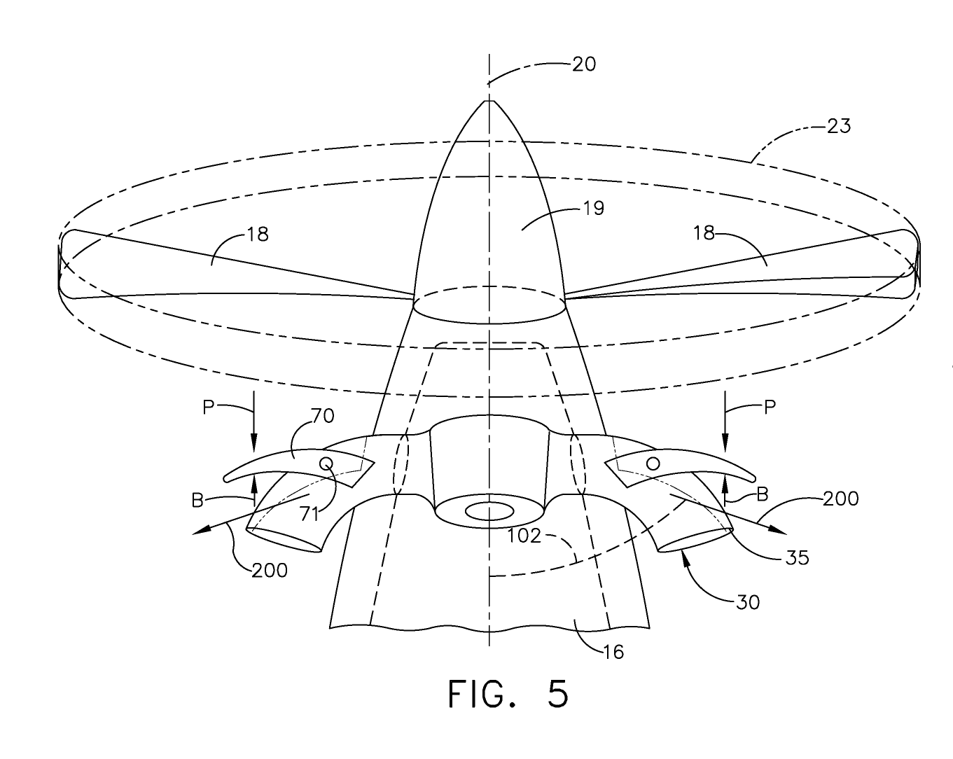

Turning to FIG. 4, the exhaust stub 30 can further include a door 70 confronting the propeller blades 18 and forming part of an outer wall of the stub 30. The door 70 can open and close about a hinge (illustrated as pivot 71), shown in a closed position in FIG. 4 and in an open position in FIG. 5. The door can be biased to an open position by a biasing force indicated by the arrow (B), and it is contemplated that the biasing force (B) can be provided by the external flow, flow of exhaust gases through the stub 30, or by a mechanical actuator as desired.

Airflows generated by the propeller rotation (also known as propeller wash) can exert a force (P) on the door 70 during operation of the engine 16. It can be appreciated that additional forces, including ram drag forces that are dependent on airspeed, can also act on the door 70. In flight, it is contemplated that the propeller wash force (P) can be greater than the biasing force (B) to close the door 70 as seen in FIG. 4. Exhaust gases flowing through the exhaust stub 30 and past the tip 35 can then be directed away from the engine 16 in a direction 100 forming a first angle 101 (FIG. 4) with the rotational axis 20. During engine idle, the propeller wash force (P) can be smaller than the biasing force (B) such that the door 70 can be in an open position as seen in FIG. 5. Exhaust gases can then exit through the door 70 and be directed further away from the engine 16 in a direction 200 (FIG. 5) forming a second angle 102 with the rotational axis 20.

A method of exhausting combustion gas from the engine 16 can include exhausting the combustion gas from the stub 30 at the first angle 101 (FIG. 4) by closing the door 70 during flight, and exhausting the combustion gas from the stub 30 at the second angle 102 (FIG. 5) by opening the door 70 during idle. The method can also include forming a pressure gradient across the exhaust outlet 32 (FIG. 3), including by way of the concave inboard portion 36 and convex outboard portion 37 (FIG. 3).

Aspects in the present disclosure can provide for a variety of benefits. It can be appreciated that hot exhaust gases can impinge heat sensitive components on the fuselage 12 or wings 14, and aspects described in the present disclosure can provide for a reduction in hot gas impingement through use of the door 70 (FIGS. 4-5) or outwardly turned tip 35 (FIG. 2). Another benefit is an improvement in air drag, where the contoured tip 35 can provide for exhausting gases in a safer direction by way of the inboard and outboard portions 36, 37 (FIG. 3), and the pressure gradient formed at the tip 35 can increase the exhaust gases' exit angle while allowing the second angle 52 (FIG. 3) to be designed as small as possible for drag reduction and for maximizing residual thrust from the exhaust. Additionally, use of the door 70 can provide for an increased exhaust angle 102 during a stage of operation where minimizing drag is less important for engine efficiency, and can also provide for a reduction in engine overheating during ground operations such as taxiing or parking. A further benefit can be found in the natural biasing force (B) (FIGS. 5-6) provided by the flow of gases through the exhaust stub 30, which can allow for the use of openable/closable doors 70 without complicated actuating mechanisms.

It should be understood that application of the disclosed design is not limited to turboprop engines, but is applicable to turbine and turboshaft engines as well.

To the extent not already described, the different features and structures of the various embodiments can be used in combination, or in substitution with each other as desired. That one feature is not illustrated in all of the embodiments is not meant to be construed that it cannot be so illustrated, but is done for brevity of description. Thus, the various features of the different embodiments can be mixed and matched as desired to form new embodiments, whether or not the new embodiments are expressly described. All combinations or permutations of features described herein are covered by this disclosure.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An aircraft engine assembly comprising:
an engine having a drive shaft with an exhaust port;
a propeller rotationally coupled to the drive shaft and defining a rotational axis; and
an exhaust stub having an inlet fluidly coupled to the exhaust port and an exhaust outlet having an outwardly turned tip.

2. The aircraft engine assembly of claim 1 wherein the exhaust stub defines a centerline and an inboard portion of the outwardly turned tip defines a concave surface and an outboard portion of the outwardly turned tip defines a convex surface when viewed in a plane containing the centerline.

3. The aircraft engine assembly of claim 1 wherein the exhaust stub comprises a first portion fluidly coupled to the exhaust port and forming a first angle relative to the rotational axis.

4. The aircraft engine assembly of claim 3 wherein the exhaust stub comprises a second portion fluidly coupled to the first portion and forming a second angle relative to the rotational axis, with the second angle being less than the first angle.

5. The aircraft engine assembly of claim 4 wherein the exhaust stub comprises a turn portion fluidly coupling the first and second portions, and wherein the outwardly turned tip is provided on the second portion.

6. The aircraft engine assembly of claim 1 wherein the outwardly turned tip, when viewed along the rotational axis, lies within a circumferential boundary formed by a full rotation of a tip of the propeller.

7. The aircraft engine assembly of claim 1 further comprising a door provided in the exhaust stub.

8. The aircraft engine assembly of claim 7 wherein the door is biased open by a biasing force.

9. The aircraft engine assembly of claim 8 wherein the biasing force is less than a force of the propeller wash during flight so that the door is closed during flight.

10. The aircraft engine assembly of claim 9 wherein the biasing force is greater than the force of the propeller wash during idle such that the door is open during idle.

11. An aircraft engine assembly comprising:
an engine having a drive shaft with an exhaust port;
a propeller rotationally coupled to the drive shaft and defining a rotational axis;
an exhaust stub having an inlet fluidly coupled to the exhaust port and an exhaust outlet; and
a door provided in the exhaust stub and operable between opened/closed conditions.

12. The aircraft engine assembly of claim 11 further comprising a biasing device applying a biasing force to the door to bias the door from the closed to the opened position.

13. The aircraft engine assembly of claim 12 wherein the biasing force is less than the force of the propeller wash during flight so that the door is closed during flight.

14. The aircraft engine assembly of claim 12 wherein the biasing force is greater than the force of the propeller wash during idle such that the door is open during idle.

15. The aircraft engine assembly of claim 11 wherein the door forms part of an outer wall of exhaust stub.

16. The aircraft engine assembly of claim 15 wherein the door forms part of the exhaust outlet.

17. A method of exhausting combustion gas from an engine rotating a propeller about a rotational axis, the method comprising:
exhausting the combustion gas from an exhaust stub at a first angle relative to the rotational axis during flight; and
exhausting the combustion gas from the exhaust stub at a second angle, greater than the first angle relative to the rotational axis during idle.

18. The method of claim 17 further comprising forming a pressure gradient across an outlet of the exhaust stub to effect the exhausting the combustion gas from the exhaust stub at the second angle.

19. The method of claim 18 further comprising opening a door in the exhaust stub during idle to effect the exhausting the combustion gas from the exhaust stub at the second angle.

20. The method of claim 17 further comprising opening a door in the exhaust stub during idle to effect the exhausting the combustion gas from the exhaust stub at the second angle.
